(19) United States
(12) Patent Application Publication
(10) Pub. No.: US 2025/0047181 A1
(43) Pub. Date: Feb. 6, 2025

(54) STATOR MANUFACTURING DEVICE

(71) Applicant: Toyota Jidosha Kabushiki Kaisha, Toyota-shi (JP)

(72) Inventors: Keisuke ITO, Toyota-shi (JP); Atsushi NAKAMURA, Fukutu-shi (JP)

(73) Assignee: Toyota Jidosha Kabushiki Kaisha, Toyota-shi (JP)

(21) Appl. No.: 18/625,397

(22) Filed: Apr. 3, 2024

(30) Foreign Application Priority Data
Jul. 31, 2023 (JP) 2023-124098

(51) Int. Cl. H02K 15/00; H02K 3/50

(52) U.S. Cl. CPC H02K 15/0081; H02K 3/50; H02K 2203/06

(57) ABSTRACT

A stator manufacturing device includes: an abutment member configured to form a bending start point in a lead wire segment coil among a plurality of segment coils inserted into a slot of a stator core, wherein the abutment member is configured to abut on a side surface of a projecting portion protruding from the slot of the lead wire segment coil from the outside in the radial direction of the stator core to form the bending start point; and a lead wire holding portion for holding the projecting portion of the lead wire segment coil, wherein the lead wire holding portion is configured to be movable along the radial direction and the axial direction of the stator core with respect to the abutment member.

### CROSS-REFERENCE TO RELATED APPLICATION

This application claims priority to Japanese Patent Application No. 2023-124098 filed on Jul. 31, 2023, incorporated herein by reference in its entirety.

### BACKGROUND

### 1. Technical Field

The present disclosure relates to a manufacturing device that manufactures a stator as a component of a rotary electric machine.

### 2. Description of Related Art

A stator is formed by bending projecting portions that project from slots of a stator core, of a plurality of segment coils inserted into the slots. The segment coils include general wire segment coils that serve as general wires and lead wire segment coils that serve as lead wires. The projecting portions of the general wire segment coils are bent in the circumferential direction of the stator, and then joined to the projecting portions of other general wire segment coils. This allows the general wire segment coils to constitute coils on the inner peripheral surface of the stator core. The projecting portions of the lead wire segment coils are bent in the radial direction and the axial direction of the stator core, and then connected to power wires that extend from connection terminals.

Japanese Unexamined Patent Application Publication No. 2016-131425 (JP 2016-131425 A) discloses an example of a technique of bending a projecting portion of a lead wire segment coil. In this technique, the projecting portion of the lead wire segment coil is bent in the radial direction of the stator core using a punch, and then a portion of the projecting portion that extends outward with respect to the stator core is bent in the axial direction of the stator core using a roller.

### SUMMARY

The stator core is provided with ribs that project in the radial direction from the outer peripheral surface. Such ribs are formed with bolt holes that receive bolts for fixing the stator core to a housing. The bending process with use of the punch and the roller cannot be performed at positions around the ribs of the stator core, since the ribs and the roller interfere with each other. In this manner, the degree of freedom in designing the positions of the lead wire segment coils may be reduced in the bending process with use of the punch and the roller. The present specification provides a stator manufacturing device capable of improving the degree of freedom in designing the positions of lead wire segment coils.

An aspect of the present specification may provide a stator manufacturing device including: an abutment member configured to form a bending start point in a lead wire segment coil, among a plurality of segment coils inserted into slots of a stator core, the abutment member being configured to form the bending start point by abutting against a side surface of a projecting portion of the lead wire segment coil that projects from the slot, from an outer side in a radial direction of the stator core; and a lead wire holding portion that holds the projecting portion of the lead wire segment coil, the lead wire holding portion being configured to be movable along the radial direction and an axial direction of the stator core with respect to the abutment member. According to this stator manufacturing device, the projecting portion of the lead wire segment coil can be bent by moving the lead wire holding portion relative to the abutment member. Therefore, the lead wire segment coil formed using the stator manufacturing device can have a high degree of freedom in design of positions.

The lead wire holding portion may be configured to be movable along the radial direction and the axial direction of the stator core with respect to the abutment member within a range of existence of the stator core when viewed in the axial direction of the stator core. The projecting portion of the lead wire segment coil formed using the stator manufacturing device is disposed on the inner side with respect to the outer peripheral surface of the stator core in the radial direction of the stator core. Thus, the stator formed using the stator manufacturing device can have a small body size.

The lead wire holding portion may include a lead wire cap that includes a recessed portion that covers a distal end portion of the projecting portion of the lead wire segment coil; The lead wire cap may include a tapered surface configured to widen an opening width of the recessed portion at a portion of an opening edge portion of the recessed portion positioned on an inner side in the radial direction of the stator core. Such a lead wire cap can hold the projecting portion of the lead wire segment coil while separating the lead wire segment coil from among the segment coils when the lead wire cap covers the projecting portion of the lead wire segment coil.

The abutment member may be configured to form a bending start point also in a general wire segment coil, among the plurality of segment coils, the abutment member being configured to form the bending start point by abutting against a side surface of a projecting portion of the general wire segment coil that projects from the slot, from a circumferential direction of the stator core. In this stator manufacturing device, the abutment member can have a function of forming the bending start point in both the lead wire segment coil and the general wire segment coil.

The stator manufacturing device disclosed herein may further include a general wire holding portion that holds the projecting portion of the general wire segment coil, the general wire holding portion being configured to be movable along the circumferential direction of the stator core with respect to the abutment member. In this case, the lead wire holding portion may include a lead wire cap that includes a recessed portion that covers the projecting portion of the lead wire segment coil. The general wire holding portion may include a general wire cap that includes a recessed portion that covers the projecting portion of the general wire segment coil. The lead wire cap and the general wire cap may have an identical shape. According to this stator manufacturing device, the manufacturing cost of the stator can be reduced, since the lead wire cap can also be used as the general wire cap.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a perspective view of a stator;

FIG. 2 schematically shows a perspective view of an intermediate part in the process of manufacturing a stator;

FIG. 3 schematically shows a perspective view of an intermediate part in the process of manufacturing a stator;

FIG. 4 is a view for explaining a step of bending a projecting portion of a lead wire segment coil, and is a view schematically showing a cross-sectional view of a slot of a stator core cut along a radial direction of the stator core;

FIG. 5 is a view for explaining a step of bending a projecting portion of a lead wire segment coil, and is a view schematically showing a cross-sectional view of a slot of a stator core cut along a radial direction of the stator core;

FIG. 6 schematically shows a perspective view of a part of the lead wire cap;

FIG. 7 is a view for explaining a step of bending a projecting portion of a lead wire segment coil, and is a view schematically showing a cross-sectional view of a slot of a stator core cut along a radial direction of the stator core;

FIG. 8 is a view schematically showing a state of an abutment member abutting on a projecting portion of a lead wire segment coil; and

FIG. 9 is a diagram schematically illustrating a perspective view of the abutment member.

### DETAILED DESCRIPTION OF EMBODIMENTS

Hereinafter, a stator which is a component of a rotary electric machine will be described with reference to the drawings. For clarity of illustration, common components may be illustrated in different drawings in different shapes, but components with common reference numerals indicate the same components.

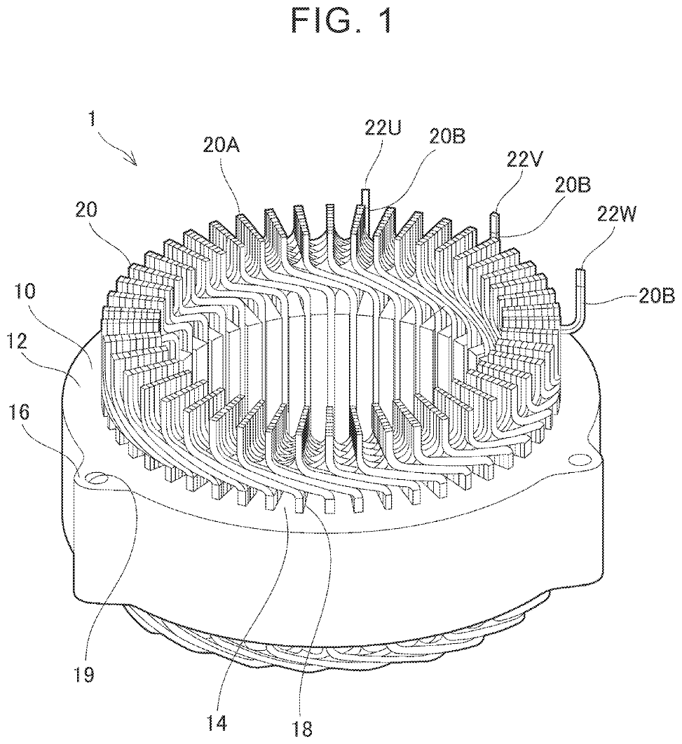

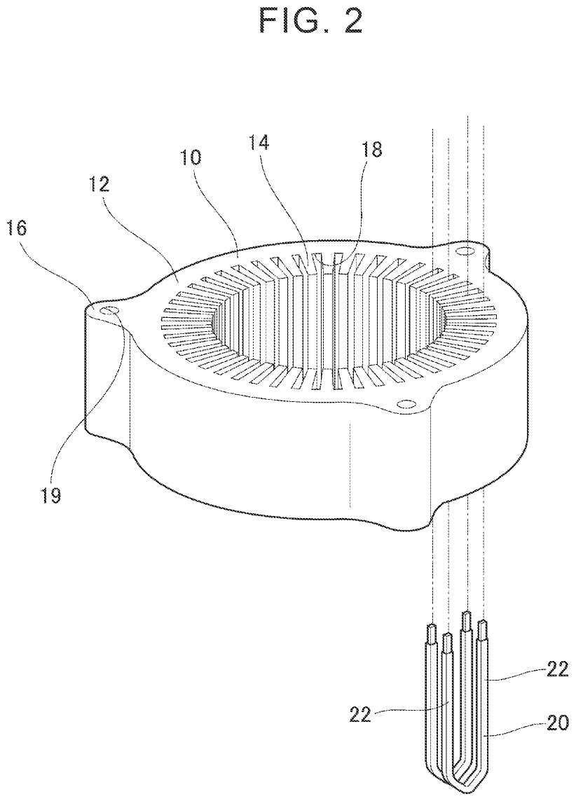

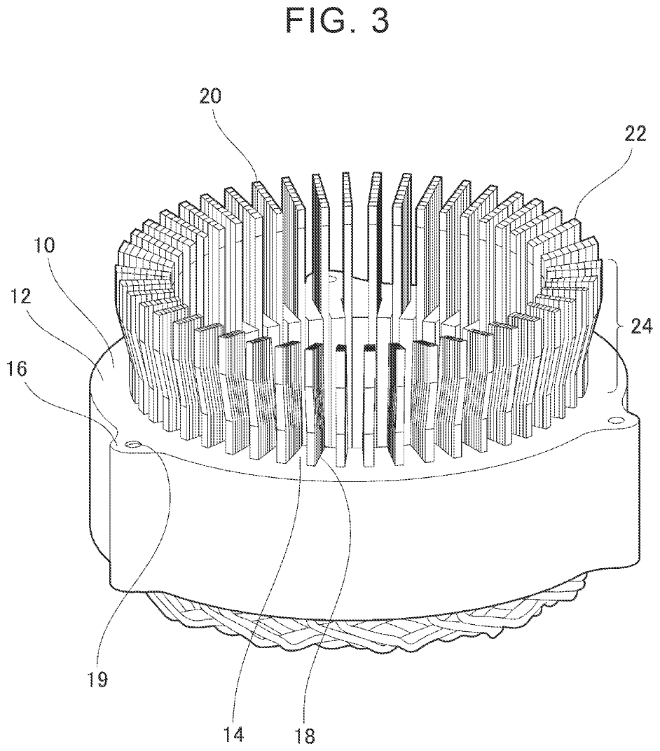

FIG. 1 shows a finished stator 1, and FIGS. 2 and 3 show intermediate parts in the process of manufacturing the stator 1. The stator 1 includes a stator core 10 and a plurality of segment coils 20.

The stator core 10 is formed by stacking a plurality of laminated steel sheets made of, for example, a magnetic material in the axial direction. The stator core 10 includes an annular yoke portion 12, a plurality of teeth 14 extending radially inward from the inner peripheral surface of the yoke portion 12, and ribs 16 protruding radially outward from the outer peripheral surface of the yoke portion 12. A rotor (not shown) is inserted into the center hole of the yoke portion 12. Each of the plurality of teeth 14 extends from one opening edge portion to the other opening edge portion of the yoke portion 12 along the axial direction of the stator core 10, and is spaced apart from each other along the circumferential direction of the stator core 10. The space between adjacent teeth 14 is referred to as a slot 18. The rib 16 is formed with a bolt hole 19 configured to receive a bolt for fixing the stator core 10 to a housing (not shown).

Each of the plurality of segment coils 20 is inserted into a corresponding slot 18 of the plurality of slots 18 of the stator core 10. Each of the plurality of segment coils 20 is a flat wire formed by covering the surface of the conductor with an insulator. As shown in FIG. 2, each of the plurality of segment coils 20 is formed into a substantially U-shape and then inserted into the slot 18 of the stator core 10 along the axial direction of the stator core 10. As illustrated in FIGS. 2 and 3, a portion of the two arm portions 22 of the segment coil 20 protruding from the slot 18 of the stator core 10 is referred to as a projecting portion 24. The stator 1 is formed by bending the projecting portion 24 of the segment coil 20 after the substantially U-shaped segment coil 20 is inserted into the slot 18 of the stator core 10. Note that the distal end portion of the projecting portion 24 has a peeled portion in which the insulator is removed and the conductor is exposed.

Here, as shown in FIG. 1, the plurality of segment coils 20 includes a plurality of general wire segment coils 20A and three lead wire segment coils 20B.

The general wire segment coil 20A is a segment coil for forming a coil on the inner peripheral surface of the stator core 10. The projecting portion 24 of the general wire segment coil 20A is bent in the circumferential direction of the stator core 10. The plurality of general wire segment coils 20A that have been bent is joined to each other by weld between the respective general wire segment coils 20A at their tips. Thus, the projecting portions 24 of the plurality of general wire segment coils 20A constitute a coil on the inner circumferential surface of the stator core 10. In this example, the U-phase coil group, the V-phase coil group, and the W-phase coil group are configured by distributed winding on the inner peripheral surface of the stator core 10. The plurality of general wire segment coils 20A also includes connecting-wire segment coils that connect the coils in-phase.

The lead wire segment coil 20B is a segment coil for providing lead wires corresponding to each of the U-phase coil group, the V-phase coil group, and the W-phase coil group. One arm portion 22 of the projecting portion 24 of the lead wire segment coil 20B is bent in the radial direction and the axial direction of the stator core 10. In this instance, three lead wire segment-coil 20B provide three lead wires 22U, 22V, 22W. The three lead wires 22U, 22V, 22W are electrically connected to corresponding power lines among three power lines (U-phase power lines, V-phase power lines, and W-phase power lines) extending from the three connecting terminals. For example, a power conversion device is connected to the three connection terminals.

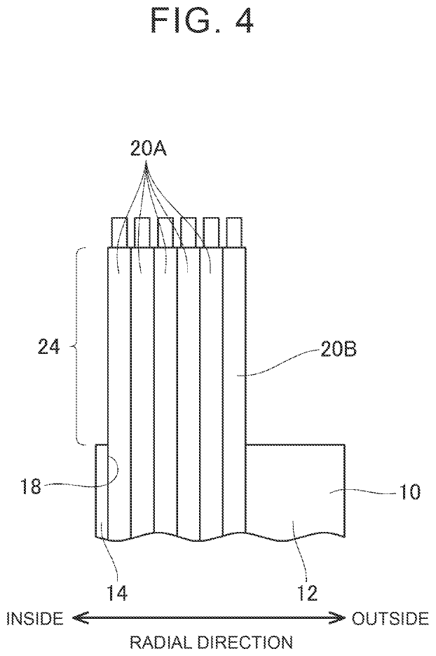

Next, methods of bending the projecting portion 24 of the lead wire segment-coil 20B will be described. FIG. 4 shows a state in which the U-shaped segment coil 20 is inserted into the slot 18 of the stator core 10. In the slot 18 of the stator core 10, the lead wire segment coil 20B is inserted in the radially outermost portion of the stator core 10, and the general wire segment coil 20A is inserted in other portions.

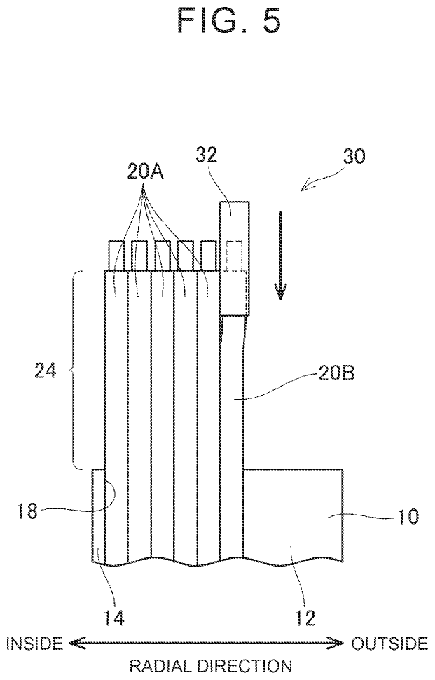

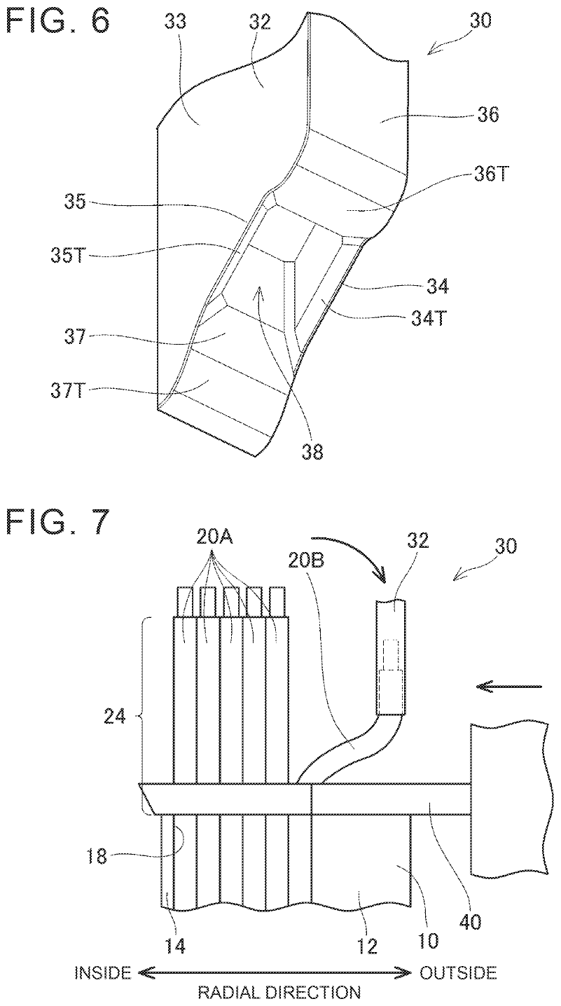

As shown in FIG. 5, the lead wire cap 32 of the lead wire holding portion 30 is lowered with respect to the lead wire segment coil 20B along the axial direction of the stator core 10, and holds so as to cover the distal end portion of the projecting portion 24 of the lead wire segment coil 20B. Here, the structure of the lead wire cap 32 of the lead wire holding portion 30 will be described with reference to FIG. 6.

The lead wire cap 32 includes a fixing portion 33 and four wall portions 34, 35, 36, and 37 erected from the fixing portion 33. The fixing portion 33 is a portion fixed to a moving device (not shown) via a fastener, for example. As a result, the lead wire cap 32 can move following the movement of the moving device. The four wall portions 34, 35, 36, and 37 include a pair of thin wall portions 34 and 35 disposed to face each other and a pair of thick wall portions 36 and 37 disposed to face each other. The thickness of the thin wall portions 34 and 35 is smaller than the thickness of the thick wall portions 36 and 37. The height of the pair of thick wall portions 36 and 37 is larger than the height of the pair of thin wall portions 34 and 35. The recessed portion 38 defined by the four wall portions 34, 35, 36, and 37 is shaped to correspond to the distal end portion of the projecting portion 24 of the lead wire segment-coil 20B. The depth of the recessed portion 38 defined by the four wall portions 34, 35, 36, and 37 is greater than the length of the peeled portion of the projecting portion 24 of the lead wire segment-coil 20B where the conductors are exposed.

The pair of thin wall portions 34 and 35 are opposed to each other along the radial direction of the stator core 10 when the distal end portion of the projecting portion 24 of the lead wire segment coil 20B is covered. Each of the pair of thin wall portions 34 and 35 has tapered surfaces 34T, 35T configured to widen the opening width at the opening edge of the recessed portion 38. The tapered surfaces 34T, 35T are not particularly limited, but may be formed of a curved surface having a radius of curvature of about 1 mm, for example. Note that the tapered surface may be formed only in the thin wall portion 34 located inside the stator core 10 in the radial direction of the pair of thin wall portions 34 and 35. The thickness of the thin wall portions 34 and 35 is not particularly limited, but may be, for example, from about 1.2 mm to about 2.4 mm. When the pair of thin wall portions 34 and 35 has such a shape, when the lead wire cap 32 covers the distal end portion of the projecting portion 24 of the lead wire segment coil 20B, it is possible to cover the distal end portion of the projecting portion 24 of the lead wire segment coil 20B while expanding between the adjoining general wire segment coil 20A.

The pair of thick wall portions 36 and 37 are opposed to each other along the circumferential direction of the stator core 10 when the distal end portion of the projecting portion 24 of the lead wire segment coil 20B is covered. Each of the pair of thick wall portions 36 and 37 has tapered surfaces 36T, 37T configured to widen the opening width at the opening edge portion of the recessed portion 38. The tapered surfaces 36T, 37T are not particularly limited, but may be formed of a curved surface having a radius of curvature of about 3 mm, for example.

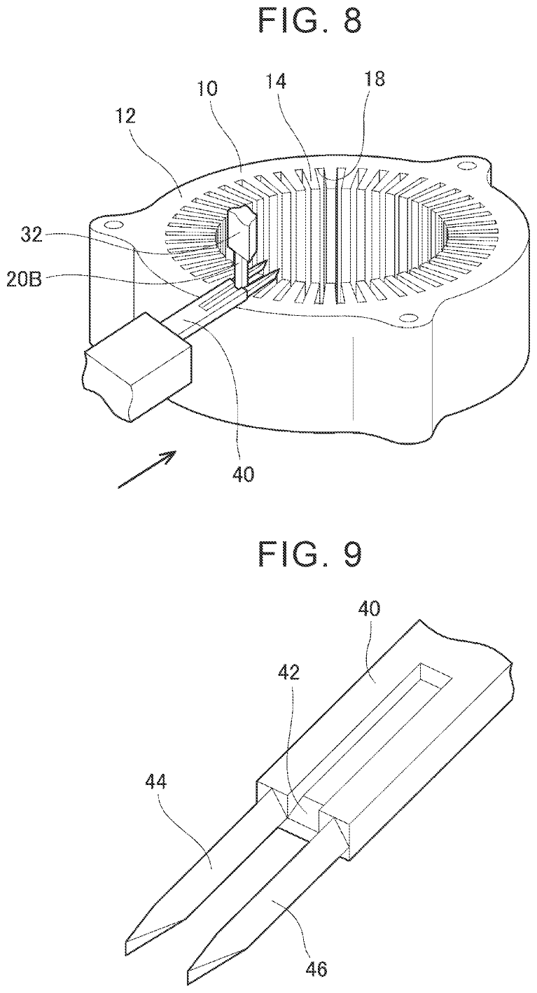

Next, as shown in FIGS. 7 and 8, the abutment member 40 configured to form a bending start point in the lead wire segment coil 20B is positioned so as to abut the side surface of the projecting portion 24 of the lead wire segment coil 20B. In FIG. 8, for the sake of clarity of illustration, only one lead wire segment coil 20B among the plurality of segment coils 20 is illustrated. The structure of the abutment member 40 will now be described with reference to FIG. 9.

The abutment member 40 includes a base portion 42 and a pair of branch portions 44 and 46 protruding from the base portion 42. When the abutment member 40 abuts against the lead wire segment coil 20B, the base portion 42 is a portion located on the yoke portion 12 of the stator core 10, the pair of branch portions 44 and 46 is a portion located on the teeth 14 of the stator core 10. The base portion 42 of the abutment member 40 abuts on the side surface of the projecting portion 24 of the lead wire segment coil 20B from the radially outer side of the stator core 10. Further, the pair of branch portions 44 and 46 of the abutment member 40 abuts against the circumferential surface of the stator core 10 among the side surfaces of the projecting portions 24 of the general wire segment coil 20A and the lead wire segment coil 20B.

As shown in FIG. 7, after the abutment member 40 abuts on the side surface of the projecting portion 24 of the lead wire segment coil 20B, the lead wire cap 32 moves with respect to the abutment member 40 while holding the lead wire segment coil 20B. The lead wire cap 32 moves radially outward of the stator core 10. Since the base portion 42 of the abutment member 40 is in contact with the side surface of the projecting portion 24 of the lead wire segment coil 20B, the abutting portion becomes a bending start point, the projecting portion 24 of the lead wire segment coil 20B is bent radially of the stator core 10. The lead wire cap 32 also moves along the axial direction of the stator core 10 in a direction approaching the stator core 10. The leading end portion of the lead wire segment coil 20B covered with the lead wire cap 32 is bent in the axial direction of the stator core 10 while maintaining the axial direction of the stator core 10. As described above, by relatively moving the lead wire cap 32 with respect to the abutment member 40, the projecting portion 24 of the lead wire segment coil 20B can be bent. This bending can be applied, for example, even in the vicinity of a position where the rib 16 (see FIG. 1 and the like) of the stator core 10 is present. Therefore, the lead wire segment coil 20B formed by the bending process can be arranged at a desired position without being influenced by the position of the rib 16, and thus has a higher degree of flexibility in designing the position.

Further, the lead wire cap 32 is configured to be movable along the radial direction and the axial direction of the stator core 10 with respect to the abutment member 40 within the existence range of the stator core 10 when viewed from the axial direction of the stator core 10. Thus, the projecting portion 24 of the lead wire segment coil 20B formed by the bending is bent so as to be disposed inside the outer peripheral surface of the stator core 10 in the radial direction of the stator core 10. Since the length of the lead wire segment coil 20B can be optimized to the extent that the power line is allowed to be connected, the usage of the coil can be reduced. Further, the projecting portion 24 of the bent lead wire segment coil 20B is covered with a thermosetting resin to ensure the insulating property. Since the projecting portion 24 of the lead wire segment coil 20B is disposed inside the outer peripheral surface of the stator core 10, it is possible to reduce the quantity of resin used.

In the above-described embodiment, the projecting portion 24 of the lead wire segment coil 20B is bent in the radial direction and the axial direction of the stator core 10. In addition, a support portion (not shown) that fixedly supports the stator core 10 may rotate about the stator core 10, so that the projecting portion 24 of the lead wire segment coil 20B may be bent in the circumferential direction of the stator core 10. As a result, the lead wire segment coil 20B can be arranged at any position in the stator 1, so that it is possible to have a higher degree of flexibility in designing the position.

In the above embodiment, the process of bending the projecting portion 24 of the lead wire segment-coil 20B has been described. In order to manufacture the stator 1, the projecting portion 24 of the general wire segment coil 20A needs to be bent in the circumferential direction of the stator core 10 to form a coil. In order to bend the general wire segment coil 20A, a general wire cap having the same shape as the lead wire cap 32 described above can be used. In this embodiment, a plurality of general wire caps are arranged side by side in the radial direction and the circumferential direction of the stator core 10, and similarly to the lead wire cap 32, each of the plurality of general wire caps holds the general wire segment coil 20A by covering the distal end portion of the projecting portion 24 of the corresponding general wire segment coil 20A. The general wire cap holds the general wire segment coil 20A, and then moves in the circumferential direction of the stator core 10 to bend the projecting portion 24 of the general wire segment coil 20A in the circumferential direction of the stator core. When the lead wire cap 32 and the general wire cap have a common shape, the lead wire cap 32 and the general wire cap can also be used. Therefore, the bending of the general wire segment coil 20A and the lead wire segment coil 20B can be performed in a common manufacturing facility, and the manufacturing cost of the stator 1 can be reduced.

What is claimed is:

1. A stator manufacturing device comprising:
an abutment member configured to form a bending start point in a lead wire segment coil, among a plurality of segment coils inserted into slots of a stator core, the abutment member being configured to form the bending start point by abutting against a side surface of a projecting portion of the lead wire segment coil that projects from the slot, from an outer side in a radial direction of the stator core; and
a lead wire holding portion that holds the projecting portion of the lead wire segment coil, the lead wire holding portion being configured to be movable along the radial direction and an axial direction of the stator core with respect to the abutment member.

2. The stator manufacturing device according to claim 1, wherein the lead wire holding portion is configured to be movable along the radial direction and the axial direction of the stator core with respect to the abutment member within a range of existence of the stator core when viewed in the axial direction of the stator core.

3. The stator manufacturing device according to claim 1, wherein:
the lead wire holding portion includes a lead wire cap that includes a recessed portion that covers a distal end portion of the projecting portion of the lead wire segment coil; and
the lead wire cap includes a tapered surface configured to widen an opening width of the recessed portion at a portion of an opening edge portion of the recessed portion positioned on an inner side in the radial direction of the stator core.

4. The stator manufacturing device according to claim 1, wherein the abutment member is configured to form a bending start point also in a general wire segment coil, among the plurality of segment coils, the abutment member being configured to form the bending start point by abutting against a side surface of a projecting portion of the general wire segment coil that projects from the slot, from a circumferential direction of the stator core.

5. The stator manufacturing device according to claim 4, further comprising a general wire holding portion that holds the projecting portion of the general wire segment coil, the general wire holding portion being configured to be movable along the circumferential direction of the stator core with respect to the abutment member, wherein:
the lead wire holding portion includes a lead wire cap that includes a recessed portion that covers a distal end portion of the projecting portion of the lead wire segment coil;
the general wire holding portion includes a general wire cap that includes a recessed portion that covers a distal end portion of the projecting portion of the general wire segment coil; and
the lead wire cap and the general wire cap have an identical shape.
